(19) United States
(12) Patent Application Publication
(10) Pub. No.: US 2016/0162789 A1
(43) Pub. Date: Jun. 9, 2016

(54) EVENT DRIVEN BEHAVIOR PREDICTOR

(71) Applicant: ADP, LLC, Roseland, NJ (US)

(72) Inventors: Isabel Espina Carvajal, Haworth, NJ (US); Roberto A. Masiero, Basking Ridge, NJ (US); Jigesh Saheba, Alpharetta, GA (US); Umakant Saraswat, Clifton, NJ (US)

(21) Appl. No.: 14/560,083

(22) Filed: Dec. 4, 2014

(51) Int. Cl. G06N 5/04

(52) U.S. Cl. CPC G06N 5/04

(57) ABSTRACT

Aspects provide for event-driven behavior prediction and include mapping a first data input to a first event of a plurality of pre-defined events as a function of an effective date of the input and identification data that is unique to an individual and a role within an organization. In response to the mapping to the first event, aspects predict (as a function of the identification data, the role and the effective date) that a second event of the pre-defined events that is linked to the first event requires an additional, second data input for the individual that is different from the first data input. Said predicting triggers an automated process that prompts a user to enter the second data input

### BACKGROUND

Human Capital Management (HCM) generally refers to functions and systems deployed in organizations that are designed to facilitate or improve employee, member or participant performance in service of an organization or employer's strategic objectives. HCM comprehends how people are identified, categorized and managed within organizations via a variety of policies and systems, for example Staffing, Human Resources (HR), Payroll, Benefits, Time, etc. HCM management systems may span different organization departments and units with distinguished activity responsibilities: examples include employee retention, recruitment, training and development, performance appraisal, managing pay and benefits, and observing and defining regulations arising from collective bargaining and governmental laws. Human Resources Information Systems (HRIS) comprehend information technology (IT) systems and processes configured and deployed in the service of HCM, and HCM data processing systems integrate and manage information from a variety of different applications and databases.

### BRIEF SUMMARY

In one aspect of the present invention, a method for event-driven behavior prediction includes mapping a first data input to a first event of a plurality of pre-defined events as a function of an effective date of the input and identification data that is unique to an individual and a role within an organization. In response to the mapping to the first event, the method further predicts (as a function of the identification data, the role and the effective date) that a second event of the pre-defined events that is linked to the first event requires an additional, second data input for the individual that is different from the first data input. Said predicting triggers an automated process that prompts a user to enter the second data input.

In another aspect, a system has a processor in circuit communication with a computer readable memory and a computer-readable storage medium having program instructions. The processor executes the program instructions stored on the computer-readable storage medium via the computer readable memory and thereby maps a first data input to a first event of a plurality of pre-defined events as a function of an effective date of the input and identification data that is unique to an individual and a role within an organization. In response to the mapping to the first event, the processor further predicts (as a function of the identification data, the role and the effective date) that a second event of the pre-defined events that is linked to the first event requires an additional, second data input for the individual that is different from the first data input. Said predicting triggers an automated process that prompts a user to enter the second data input.

In another aspect, a computer program product has a computer readable hardware storage device with computer readable program code embodied therewith. The computer readable program code includes instructions for execution by a processor that cause the processor to map a first data input to a first event of a plurality of pre-defined events as a function of an effective date of the input and identification data that is unique to an individual and a role within an organization. In response to the mapping to the first event, the processor further predicts (as a function of the identification data, the role and the effective date) that a second event of the pre-defined events that is linked to the first event requires an additional, second data input for the individual that is different from the first data input. Said predicting triggers an automated process that prompts a user to enter the second data input.

### BRIEF DESCRIPTION OF THE SEVERAL VIEWS OF THE DRAWINGS

These and other features of this invention will be more readily understood from the following detailed description of the various aspects of the invention taken in conjunction with the accompanying drawings in which:

FIG. 1 is a flow chart illustration of a method or process for event-driven behavior prediction according to an aspect of the present invention.

FIG. 2 is a diagrammatic illustration of interrelationships between predefined mapable events and HCM system inputs and processes according to the present invention.

FIG. 3 depicts a computer device according to the present invention.

### DETAILED DESCRIPTION

Human Resources Information Systems (HRIS) capture, identify, label and change the properties of input data. However, such systems are generally unable to capture the intent of why data was entered or changed. For example, an employee may engage an HRIS through a graphical user interface (GUI) dashboard to provide or change personal information including name, address, gender, birthday, and unique identification numbers (employee, social security, drivers' license, et cetera). But the mere entry of such data does not explain why the data change or entry was made, the underlying intent.

For example, entry of a change in data may be due to discovering a previous entry error, or it may signify an event that has implications on other data: Was the previous address entry wrong, or did the employee move? Is the move due to a change in employment, such as a hiring, resignation, promotion, relocation, or re-hiring after a leave, etc.? Thus, different events may be associated with different data entries, based on the underlying intent. If in response to a hiring, other personal data must generally be entered for the first time, while other change of employment events with regard to a current employee may be associated with different new data entries, or revisions to existing data: For example, retirement account information on file may remain unchanged in the case of a resignation, promotion, or re-hiring, but a relocation to a different national jurisdiction may require an update as to tax withholding and deferment status. A resignation may trigger a need for an input that identifies a financial service company to receive a roll-over of funds in a retirement plan administered by a current employer.

A change in marital status data may be associated with a wide variety of other required or possible different data entries that are associated with different events underlying the change. The mere entry of a marital status change by itself does not give an indication that a tax withholding data change is likely, advisable or required. It does not necessarily involve a change in legal name or domicile, but such changes if they have also occurred should be entered in the HCM system.

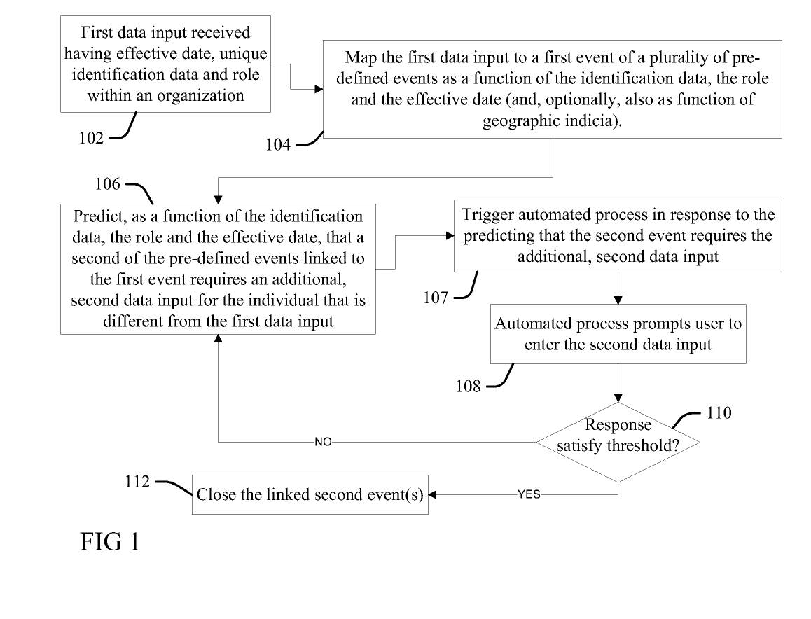

FIG. 1 illustrates a method, system, or process for event-driven behavior prediction according to an aspect of the present invention. At 102 a first data input is received with respect to a personal data item associated with a unique individual in the context of an organization (business, company, governmental entity, etc.). More particularly, the first data input includes (at least) an effective date of the input, identification data that is unique to an individual associated with the first input, and a role of the individual within an organization The individual may be an employee individual already within the organization, or a candidate for entry into the organization (for example, as recognized via a job offer or incentive package created for or extended to the individual).

In response to the first data input, at 104 an event-driven behavior predictor (for example, a hardware processor of a client-server computer that is executing programming code, or other automated human resource management system hardware processor component) maps the first data input to at least one (first) event of a plurality of pre-defined events as a function of identification data that is unique to the individual and that includes a role of the individual within the organization (title of current or proposed role within the organization, and status as employee and/or candidate); an effective date and/or time or other temporal data of the data input 102 (for example, a current date and time of entry of the input, or another earlier or later date or time at which the data input effects or satisfies a condition of a HCM task or process). The temporal data may also include a date and/or time of another data input or entry of another, different (second) data item that is linked to or otherwise associated with the personal data item of the data input 102. In some examples geographic indicia of the individual or a current/proposed role of the individual within the organization (domicile, etc.) is also considered and used to map the event(s) at 104.

At 106 the behavior predictor predicts, as a function of the identification data, the role and the effective date, that one or more (second) events of the pre-defined events that is (are) linked to the first event requires an additional, second data input for the individual that is different from the first data input (and, in some aspects, as a function of the geographic indicia).

At 107 an automated process is triggered in response to the predicting that the second event requires the additional, second data input, which at 108 prompts a user (for example, the individual or manager thereof or other person within or outside of the organization) for response input to enter the second data input.

At 110 an automated component determines whether a data input received in response to the prompt at 108 satisfies a specified satisfaction threshold. In response to determining that the received data input satisfies the satisfaction threshold, the behavior predictor closes the second event(s) at 112. Else, the process keeps the second event open and iteratively repeats the steps of predicting at 106, triggering the automated process at 107 and prompting for data at 108 and determining whether received data input responses satisfy the threshold at 110, until said satisfaction threshold is met.

As each iteration of predicting data items at 106 is a function of the mapped event, the identification data, the role of the individual within the organization, and the temporal data (and, in some aspects, of the geographic indicia data), the predicted data items may change between iterations prompted at 110 due to changes in the values of data items during intervening iterations. Thus, the predictions of data items that require data inputs at 106 may dynamically change over time as functional data input values change.

The events mapped at 104 to the data input 102 are chosen from a set of predefined events that are defined to capture an intent of the data input 102 extracted from the interaction with the system as a function of context set by personal data associated with the individual and his/her relevant role within the organization. By gleaning the intent of the data entry 102, events are recognized and mapped at 104 that provide context and indicate other appropriate or required data entry requests predicted at 106 and prompted at 108.

The predefined events are given unique, canonical names that are generally descriptive within an Event API. More particularly, an associated data object is canonicalized into a unique representation from a previous generic form of descriptive word terms that have more than one possible representation. The canonical names are associated with descriptions in an Event API envelope schema for use in application of the events and in mapping to the inputs at 102. Each instance of an event has a unique identifier and captures temporal data associated with the mapped event, generally with a plurality of different time data entries, for example when the data entry mapped to the event was created, when it was recorded, when an entry completing (satisfying) the mapped event was entered or occurred or is effective, etc. Events may also capture identification data as to who or what (for example, an automated device) originated a mapped event occurrence.

Exemplary envelope components, wherein the first key is data (the actual response item requested, such as an object itself or a list of objects) and the second key is meta (code corresponding to an object of the first key and containing additional information about the request), include the following:

eventID—A unique identifier of the event instance.

serviceCategoryCode—The service domain (for example, HR, Payroll, Benefits, etc.); this is always present and valued based on a standard.

eventNameCode—This is the canonical name of the event. Examples include “dependent.add” and “worker.hire.” This field is always present and valued based on a standard codelist.

EventStatusCode—Status of the event. Values are canonical

eventReasonCode—Reason code for the triggering of the event, for example, “worker.marital-status.changeeventreason.code=M,” “event.reason.shortName=Marriage.”

permissibleStateCode—This canonical object states or defines what the event state may be changed to by a client.

priorityCode—The priority which the event has for example, (high, normal, low, etc.).

creationDateTime—The date that the event is created

recordDateTime—The date that the event is recorded with the “event.status.code=complete.”

expirationDateTime—The date when the event expires. That is, it may no longer be completed.

effectiveDateTime—Effective date time of the event.

dueDate—The date in which the event is due. Allows for reminders to be generated.

originator.associatOID—Associate Originator Identification (“OID”) of originator of the event. For example, when a user declares an event the “originator.associatOID” data is populated with the Associate OID of the user. This property is optional and depends on whom or what originated the event.

originator.eventID—Returns “eventID” data of the event which triggered this event. For example, an opportunity to enroll in benefits event triggered this subsequent event, which is to be completed by the user. (Optional—This property is optional and depends on who/what originated the event, and is only relevant if initiated by another event.

originator.machineID—Identifier of the machine which initiated this event. (Optional—only relevant if initiated by an automated device, process or machine.)

originator.componentID—Identifier of the component which initiated this event. (Optional—only relevant if initiated by a component of an HCM process via an automated device, process or machine.)

actor.associateOID—Associate OID of the user which completed the event. (Optional—only relevant if completed by a human.)

actor.machineID—The machine ID which completed the event. (Optional—only relevant if completed by an automated device, process or machine)

actor.componentID—Identifier of the component which completes the event.

actor.geoCoordinate.latitude—Latitude, the decimal value of the location where the actor completed the event. (Optional—Relevant for a human actor who allows his/her location to be captured.)

actor.geoCoordinate.longiitude—Longitude decimal value of the location where the actor completed the event. (Optional—Relevant for a human actor who allows his/her location to be captured)

actor.geoCoordinate.altitude—Altitude decimal value of the location where the actor who completed the event. (Optional—Relevant for a human actor who allows his/her location to be captured.)

actor.deviceUserAgentID—Identifier of the user's device user agent. (Optional—Relevant if the system is able to capture the device's user agent.)

The Event API maintains the envelope data (first key) through the life of the recording of the event, and sets context of the events. The Event API also provides the input data needed to complete the event, in effect, reference data (for example, in a survey conversation with a user, providing a set of questions and related answers). Transient data which a user provides to complete the recording of the event is transformed, and the output is the recorded event (i.e. the result). The Event API envelope Meta data describes how to complete an event, providing validation rules.

In some HCM system implementation aspects the predefined events are organized with respect to different domains within an organization, and into different categories within the domains. In one example events are distributed between Benefits and HR domains within an organization (company, governmental department, etc.).

Events within the Benefits domain are further categorized as within Beneficiary Management or Subscriber Enrollment categories. Beneficiary Management events include “beneficiary.add” (A worker declares a beneficiary), “beneficiary.change” (worker updates an existing beneficiary) and “beneficiary.remove” (worker removes a beneficiary) (wherein the string in quotes in the first key data, and the text in quotes is the second key Meta, of the EPI event envelope). Subscriber Enrollment events include “benefit.beneficiaryDesignation.change” (change the designation of beneficiaries to a coverage) and “benefits.enroll” (health and welfare enrollment opportunity).

Examples of event categories with the HR domain include Dependent Management, LOA (“Leave of Absence”), Worker Assignment Lifecycle, Worker Lifecycle, Worker Biological and Worker Civil Status. Dependent Management events include “dependent.add” (worker adds a dependent), “dependent.change” (worker updates an existing dependent) and “dependent.remove” (worker removes a dependent). LOA events include “worker.leave.request” (worker requests a leave of absence) and “worker.leave.review” (worker's leave of absence request is reviewed; result is it is approved, rejected, etc.).

Worker Lifecycle events include a number of straightforward events with self-descriptive names, including “worker.hire,” “worker.start,” “worker.onleave,” “worker.laidoff,” “worker.rehire,” “worker.resign,” “worker.retire,” “worker.terminate” and “worker.deceased.”

Worker Assignment Lifecycle events are mapped to variety of changes in worker duties and status while employed, and in some aspects differ on the basis of values of one of two or more parameters that may independently vary between different events. Thus, Worker Assignment Lifecycle events provide finer detail for mapping to worker data inputs than the Worker Lifecycle events, and may more accurately capture the intent behind the data input at 102. Example of Worker Assignment Lifecycle events include “worker.demote” (for application where worker's level is changed/demoted but functional capabilities remain the same), “worker.job.change” (worker changes his/her functional responsibilities without demotion or promotion), “worker.promote” (for application where worker's functional capabilities remain the same, but worker's level is changed), “worker.workAssignment.additionalRemuneration.change” (amount of worker non-salary remuneration is changed, for example, bonus, commission, etc.), “worker.workAssignment.baseRemuneration.change” (amount of salary or other base remuneration is changed), “worker.workAssignment.assignedWorklocation.change” (worker's assign work location is changed, but not domicile of the worker), “worker.workAssignment.homeWorklocation.change (worker's domicile location is changed, but not the assigned office or work location), “worker.workAssignment.onLeave” (a worker is on leave from a specific assignment), “worker.workAssignment.standardHours.change” (the standard number of hours in the work week/month/day/etc. specified for this worker is changed), and “worker.workAssignment.workLevel.change” (the work level of the worker is changed, for example, part-time to full-time, while the functional capabilities and/or level of employee remain unchanged).

Worker Biological events are mapped to changes or corrections in personal demographic aspects and examples include “worker.birthdate.change” “worker.gender.change” and “worker.race.change” (wherein the context or framework of an ethnic, national or racial classification of the worker may be changed). Worker Civil Status events are mapped to inputs with respect to citizenships and work permit and residency statuses of workers, and include “worker.citizenship.add” (a worker adds a country of citizenship), “worker.citizenship.remove” (a worker removes a country from a listing of citizenships), “worker.residency.add” (a worker adds a country for which he/she has been granted legal residency status) and “worker.residency.remove (a worker removes a country from designation for legal residency status).

A declarable event is one which a user initiates, wherein the user must inform the system that the event occurred. The system expects certain data in order to record the event. Examples of declarable events include marriage (“worker.marital-status.change”) and birth of child (“worker.dependent.add”) events. In one example “Get/events/meta?contextExpressionCode=DE” provides an authorization call (“associateAuthorization”) to return a collection of events which the user is authorized to declare and the associated meta on how to declare in the given context. A user may also see a list of all events via using a “Get/events” call, which gets a collection of event instances, wherein each event instance has the following information: Event Instance Identifier, Event type, Event creation date, Event status and Event data (input, transform or output). “Get/events/hr/worker.dependent.add/meta” provides the metadata for the “worker.dependent.add” event, returning the properties and the rules to set context (i.e. who am I adding a dependent to and in what context, for example, a German Worker) and the properties and the rules for the transform (i.e., the data user must provide to declare the event).

An automated HCM system (for example, a processor in circuit communication with a memory and executing instructions residing thereon) may automatically and directly create an event instance for a user to complete, in some aspects as part of a process. Examples of system generated events include “benefits.enroll” and “wellness-survey.complete” events.

Event Notification: Each event triggers an event notification that includes an event ID, an event type, event creation date (and optionally time), and the data that indicates the data impacted as a result of the event (i.e. output) and a link to the event instance.

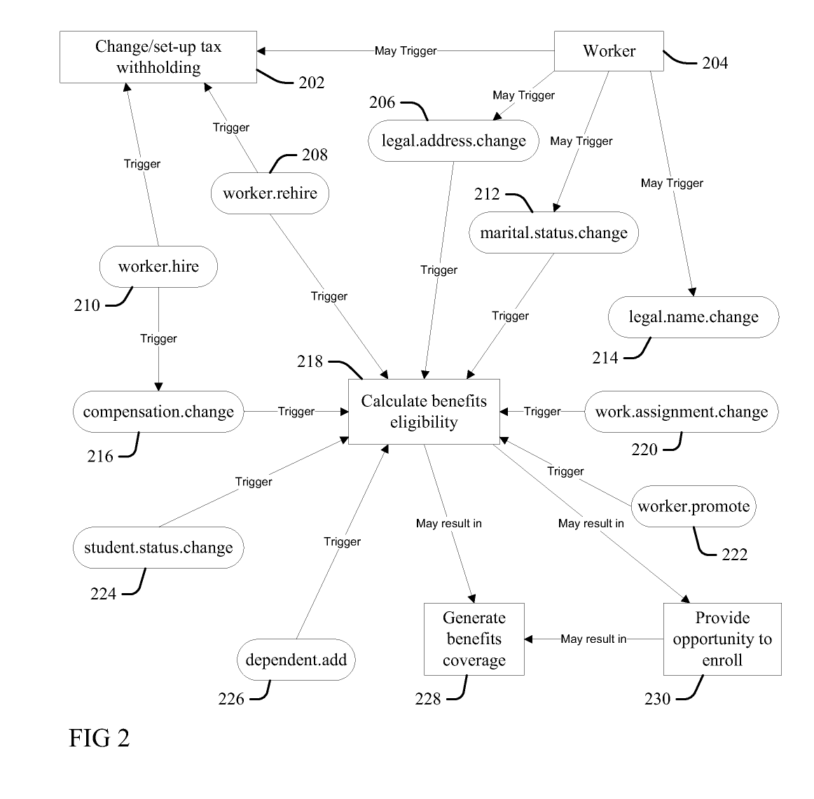

FIG. 2 illustrates one example of the interrelationships between the predefined mapable events and HCM system inputs and processes according to the present invention. A worker 204 input may directly trigger a “Change tax withholding” process 202, or be mapped to (and thereby may trigger) a “legal.address.change” event 206, a “marital.status.change” event 212 and a “legal.name.change” event 214. The “legal.address.change” event 206 and “marital.status.change” event 212 trigger a “Calculate benefits eligibility” process 218, and thus the process 218 may be automatically triggered in response to mapping an associated input 102 from the worker to either of the events 206 and 212 (for example, at 104 of FIG. 1).

Another data input (for example, at 102 of FIG. 1) is mapped to the “worker.hire” event 210, which triggers the “Change tax withholding” process 202 and also a mapping to another event, the “compensation.change” event 216, which triggers the “Calculate benefits eligibility” process 218. A data input mapped to the “worker.rehire” event 208 directly triggers the “Change tax withholding” process 202 and the “Calculate benefits eligibility” process 218.

Other events mapped to data inputs that trigger the “Calculate benefits eligibility” process 218 include the “work.assignment.change” event 220, the “worker.promote” event 222, the “dependent.add” event 226 and the “student.status.change” event 224. The “Calculate benefits eligibility” process 218 may directly result in a process for generating benefits coverage at 228, or in a process for providing an opportunity to enroll in benefits at 230, which may result in generating benefits coverage at 228 (for example—if the worker takes advantage and responds to the opportunity at 230).

In the prior art a given data input recorded into an HCM system that an individual employee got married may not suggest or require a change in or updating of name or tax withholding status of the employee, if not required as a function of governmental or organization regulations or rules. If there is no applicable HCM rule, procedure, flow chart or matrix process linking the data items, under prior art HCM systems no inquiry is required or will be generated to update name and/or tax withholding status due to acknowledging the change in marital status.

In contrast, the behavior predictor according to the present invention uses the relations of the predefined event(s) mapped to a given data input to predict a context of the data entry defined by personal employee data of the individual (for example, as indicated by the behavior of others within the same salary or salary band pay scale), the role of the individual within the organization (what others of similar role or job titles in the organization have done when newly married), and temporal data (noting that others with similar salary and job titles change their withholding status after a change in marriage status by the next tax year). The predictor compares the context of this input for this individual to data that is anonymized and aggregated from a plurality of other individuals that are employed within other organizations that are each analogous to the organization of the present data context. This comparison determines that the data input context establishes a high likelihood that the user will wish to change their tax withholding status or their name in response to the change in marital status, and therefore map the data input to a “change in marital status” event, also to tax withholding status change and name change events. The geographic indicia data may also set this context, further indicating the high likelihood of the links between these events as noted by the behavior of others within an applicable national taxing domicile region of the data change. Accordingly, the behavior predictor will prompt the individual to confirm or change their withholding status and/or name at 108. Satisfaction of a response to the prompt may include a response from the individual, or a change or confirmation of no change by a human relations person with requisite status or authority within the organization.

The prompts at 108 may be voluntary and discretionary: for example, “Oh, I see you got married. Would you like to change your tax withholdings?” This emphasizes the predictive nature of the linking, acknowledging that no particular rule requires this additional data entry and reducing the likelihood that the user may be annoyed or feel over-burdened in providing data inputs to one more in a series of HCM systems requests. It may further offer additional information to help with the response from the API envelope Meta information: “Oh, let me tell you about benefits that are available for your new spouse: would you like to explore health insurance options?” It may also predict that other, non-required data entries are probably also occurring, and prompt for this information: “Did you also change your name?” Applicable rules or social norms may indicate that the mere fact that an individual got married does not indicate a required or likely change in name, and these are separate events in the world. However, the behavior predictor may recognize that these things are very commonly related within the data context of this individual/organization/temporal setting (and, optionally, geographic setting). A behavior predictor implemented within a benefit system listens to the context of the data input and recognizes this is not just a singular data input or change, but an indicator of an underlying event that likely triggers one or more additional data inputs or queries, for example with regard to calculating eligibility for a spouse for employee benefits, resulting in a predicted prompt sent to the individual at 108 via an email that states “By the way, you can enroll your spouse, now, shall we begin?”

Aspects of the present invention go beyond responding to data changes via applications of direct rule linkages, beyond mere automated record keeping wherein users of a HCM system must process a set series of menus in a conventional application programming interface (API). While the prior art HCM systems allow changing data properties, they don't capture the intent of why something was changed by considering differences in individual, organization, temporal setting (and geographic setting) contexts that vary between different inputs of the same data item. In one aspect automated processes of the present invention engage in a conversation with the individual providing the data, resulting in a series of prompt iterations at 108 as a function of dynamic patterns defined over time.

Aspects of the mapped events are defined over temporal time periods or timelines, wherein an event is a thing that happens and may have different dimensions over time that are recognized by applying business intelligence in making predictions for subsequent data prompts at 106 and 108. For example, in the case of an employee making a benefit election, beyond offering choices, a context setting of who made the election and when enables a prediction of another data entry prompt: distinguishing a change in benefits made during an open enrollment election period from one made outside of said period, to predict in response that some other change in status (new dependent, etc.) probably occurred that will require additional data processing and/or queries, and therefore wherein other appropriate events (including the “worker.dependent.add” event) are further linked or mapped to the mapped event.

In some aspects a “worker's seed” event is defined for mapping to an offer of employment extended to an individual. If accepted and they're hired this event closes out and the behavior predictor progresses/maps to another event, “new employee hire”, triggering a related first sequence of response prompts 108 via different processes. If the worker starts employment the seed event closes out and maps to a “new employee starts work” event, which may start another sequence of response prompts 108 via different HCM processes. However, if the offer is not accepted, but is declined right before expiration (for example, the day before they're supposed to start), this temporal context may indicate that the individual received an acceptable counter offer from another entity (in contrast to offers declined earlier in the process, or closer to date of offer and remote from the expiration of the offer period). Accordingly, the seed event may close out and the predictor map to a different “offer rejection” event, wherein the offer is cancelled and a different predicted data item prompt 106 is generated: “Did you receive a better offer? What terms in that offer made it a better offer?”

Prior art systems generally collect data in a sequential and precedential fashion, wherein some items may not be collected until certain conditions are met: in response to hiring a worker the payroll department is notified, and once they have satisfied their data needs a retirement department is notified, etc. In contrast, as illustrated by the diagram of FIG. 2, by mapping a data entry to a predefined event, a plurality of other events or processes may be triggered and opened, resulting in simultaneous, parallel processes or conversations engaging an employee. For example, while the worker 204 is submitting employability proof (for example, supplying certain documents to establish a change in legal address to satisfy event 206, to prove that they are authorized to work in the domicile), another mapped event (for example, worker.hire 210) may start simultaneously a conversation on setting up tax withholding via the process 202, and another mapped event (dependent.add 226) a conversation as to declaring dependents. All these are separate events, and each one of them can start triggering other events in a parallel business process that facilitates meaningful and contextual data integration. Any given business process within disparate systems may listen to one event that's important or relevant to it, and then proceed from that event to a next.

Event mapping and data item predicting are individual transactions that are related to each other by the event-driven behavior predictor, via recognizing, defining and maintaining (updating in response to results from each iteration) event patterns that have temporal aspects. For example, an input 102 of a change in marriage status may indicate that the change actually happened at an earlier date in the past, which may trigger recognition that the effective day for benefits offer to the spouse is also a date in the past, which may expose the organization to granting retroactive coverage via the process 228, and wherein additional information about the spouse during that intervening period (for example, their employer during that time, or status as custodial parent of dependents) may be required via an appropriate defined event to move benefit calculations forward. Events may thereby have more dimensions beyond the present, and may trigger other events or opportunity to declare some other event in the past, present or future.

The process at 106 may provide dynamic security level and permissions in mapping, linking and implementing events through the Event API. More particularly, the predictor may recognize that it is common for employees to effectively delegate the choices for enrolling in certain benefits (health insurance, retirement savings accounts, etc.) to their spouses, wherein the non-employee spouse does all the research and the due diligence and makes the choices and relays them to the employee for entry. However, the non-employee spouse does not have access to the associated HCM system fields to glean all the desired or necessary information to make an informed choice within HCM system dashboards or other entry points, which may result in undesirable mistakes or delays in accurately issuing desired benefits to the employee. Accordingly, the behavior predictor may recognize that the context of this individual indicates that the HCM system should grant limited authorization to the employee spouse to directly interact with the associated HCM systems (for example, at 230 of FIG. 2), thereby expanding HCM systems capabilities while keeping other elements of the HCM system secure from access by the spouse. Thus, different levels and security permissions may be predicted or otherwise implemented at 106, wherein security aligns with the data processes predicted to depend from the original data input at 102.

Security may also be dynamically allocated between employees in response to predicted needs and requirements. For example, a manager may have the requisite authority to update a specified object with personal information for an employee, and not the employee. However, the employee may have knowledge relevant to the data object that is personal and confidential nature (for example, information of a health condition of a dependent that is confidential pursuant to governmental regulations). The behavior predictor may recognize (as a function of the organizational data context at 104) that a change in beneficiary input at 102 is typically associated with changes in dependent health conditions that are historically confidential, and thereby grant manager security privileges to the employee that are limited to a designated personal data item at 106 subject to a prompt at 108, thereby aligning the security needs of the organization with confidentiality obligations. Aspects may thereby tie appropriate authorizations to mapped events, and configure and present Event API user interfaces (UI) appropriately.

Aspects may also enable dynamic managements of an event life cycle at 110. For example, an individual may declare a new dependent due to childbirth. An HCM system may require the name, gender, birth date, and social security number to recognize a successful declaration of the dependent within the HCM system with the USA as a domicile. If the individual does not have all of this information for entry, for example does not know the social security number, the individual may try to leave the event in an in-progress kind of mode, and exit. Rather than issue an error message, as may happen in prior art systems, aspects of the present invention recognizes that the individual intends to finish later, that the missing data is not an error of omission but conveys an intent to return at a subsequent time to complete the process with the missing information. The predictor can then adjust the expiration of the life cycle of the event, and hold the data for a specified additional time period, and in some aspect to prompt the individual at the end of the period:, for example sending a prompt at 108 of “Last week you told me about a new dependent, but did not provide the social security number; do you have this number yet?”

Aspects of the present invention engage in a conversation with a user (individual), moving from data processing to wisdom, gleaning the reason or intent behind the data change. Knowledge is learned through experience in processing the same or similar (analogous) sets of data from a perspective of the predictor, enabling the system or process to put a story together, pieced from things that happened over a temporal time period that may be defined as events that provide a pattern used in predicting appropriate data inputs not otherwise indicated by typical HCM rules and processes. For example, an employee may register classes taken or projects completed, which indicate an increase in job knowledge and experience over time. Managers may also be entering performance reviews indicating a high performance level relative to other employees. A behavior predictor according to the present invention may compare this data to a present job description and recognize at 104 and 106 that the employee is doing a greater amount of work than expected based on the present job description, and thereby map a promotion event to this individual and open a conversation with a manager of the individual, in some aspects as a function of known job churn rates for this position in an indicated domicile. Thus, a prompt may be generated to a manager at 108 stating “You should promote the employee: though she would typically remain for another two years at the current position (based on job title, date of hire and churn rate for this position in this domicile), based on accomplishments and performance reviews over the last year she has grown out of her current role and is ready for promotion now; else she is likely to seek a better offer from a competitor.”

Aspects also capture event patterns for use in prediction processes. For example, the predictor may recognize that a manager that has a duty to approve time sheets generally approves them every week without correction unless a specific type of exception occurs. Accordingly, the predictor could map the occurrence of this specific type of exception to an “exception event” at 104, and at 106 predict that the manager would agree to an automated approval process opportunity that automatically approves other time sheets without this exception, prompting the manager at 108: “Would you like me to approve all time sheets submitted for this group for payroll unless they have this specific type of exception?”

In another example each of a plurality of employee review inputs may be termed individual “rating” events. If a threshold number of the events from different people each have a threshold high rating occur and over a specified temporal time period (for example, five, five-star rating by different work group managers for different tasks within three months), the process may infer that the employee is performing exceptionally and (as a function of the individual, organizational, temporal and geographic indicia context) merits consideration for promotion earlier than would otherwise be indicated merely in response to the rating event inputs. For example, five, five-star rating by different managers for different tasks within three months, may be deemed significant (meeting a threshold for action) as a function of a first role defined within an organization (such as a truck driver who has a low frequency of task occurrences rated by managers), wherein for a second role this would not meet the threshold role of the employee (for example, a coffee shop server who encounters multiple managers in multiple transactions every day).

Event mapping enables aspects of the present invention to capture event patterns for use in prediction processes from anonymized data, data from which confidential and identification data has been removed. By using data identified and characterized by generic title and job description descriptors from multiple, different organizations, the data may be stripped of identifiers linking it to any one individual or organization. With increasing amounts of organization data, benchmark event and thresholds may be defined by industry, geography, etc., which are useful in making predictions.

Aspects of the present invention include systems, methods and computer program products that implement the examples described above. A computer program product may include a computer-readable hardware storage device medium (or media) having computer-readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

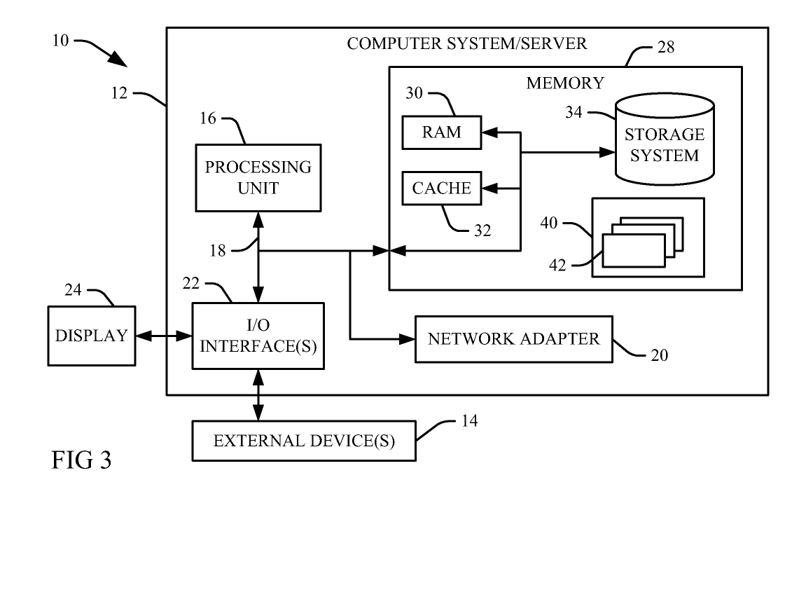

Referring now to FIG. 3, a computer system/server 12 is operational with numerous other computing system environments or configurations for score-based title assignment according to the present invention. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

Computer system/server 12 in a cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of a non-limiting example, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks, such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

In one aspect, a service provider may perform process steps of the invention on a subscription, advertising, and/or fee basis. That is, a service provider could offer to integrate computer-readable program code into the computer system/server 12 to enable the computer system/server 12 to perform score-based title assignment as discussed in the Figures. The service provider can create, maintain, and support, etc., a computer infrastructure, such as the computer system 12, bus 18, or parts thereof, to perform the process steps of the invention for one or more customers. In return, the service provider can receive payment from the customer(s) under a subscription and/or fee agreement and/or the service provider can receive payment from the sale of advertising content to one or more third parties. Services may include one or more of: (1) installing program code on a computing device, such as the computer device 12, from a tangible computer-readable medium device 34; (2) adding one or more computing devices to the computer infrastructure 10; and (3) incorporating and/or modifying one or more existing systems 12 of the computer infrastructure 10 to enable the computer infrastructure 10 to perform process steps of the invention.

The terminology used herein is for describing particular aspects only and is not intended to be limiting of the invention. As used herein, the singular forms “a”, “an” and “the” are intended to include the plural forms as well, unless the context clearly indicates otherwise. It will be further understood that the terms “include” and “including” when used in this specification, specify the presence of stated features, integers, steps, operations, elements, and/or components, but do not preclude the presence or addition of one or more other features, integers, steps, operations, elements, components, and/or groups thereof. Certain examples and elements described in the present specification, including in the claims and as illustrated in the figures, may be distinguished or otherwise identified from others by unique adjectives (e.g. a “first” element distinguished from another “second” or “third” of a plurality of elements, a “primary” distinguished from a “secondary” one or “another” item, etc.) Such identifying adjectives are generally used to reduce confusion or uncertainty, and are not to be construed to limit the claims to any specific illustrated element or embodiment, or to imply any precedence, ordering or ranking of any claim elements, limitations or process steps.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for event-driven behavior prediction, the method comprising:
in response a first data input that comprises an effective date of the input and identification data that is unique to an individual and a role within an organization, mapping the first data input to a first event of a plurality of pre-defined events as a function of the identification data, the role and the effective date;
in response to the mapping to the first event, predicting, as a function of the identification data, the role and the effective date, that a second event of the pre-defined events that is linked to the first event requires an additional, second data input for the individual that is different from the first data input,
triggering an automated process in response to the predicting that the second event requires the additional, second data input; and
the automated process prompting a user to enter the second data input.

2. The method of claim 1, wherein the second event of the pre-defined events is linked to the first event as a function of aggregated anonymized organizational data of a plurality of other individuals that are employed within other organizations that are analogous to the organization, wherein confidential data and identification data that identify the other individuals are removed from the aggregated anonymized data.

3. The method of claim 2, further comprising:
mapping the first data input to the first event as a function of a relation of at least one of a salary level of the individual, a job title of the individual within the organization, and a length of time of the individual within the job title at the salary level, to corresponding data within the aggregated anonymized organizational data.

4. The method of claim 2, further comprising:
automatically revising a security setting of an application programming interface of the organization to enable a spouse of the individual to enter the second data input, as a function of recognizing that the aggregated anonymized organizational data indicates that it is likely that the spouse is able to provide a data input response that satisfies a satisfaction threshold of the automated process.

5. The method of claim 2, further comprising:
capturing an event pattern as a function of the identification data, the role and the effective date of the first data input, in view of the aggregated anonymized organizational data; and
the automated process approving entry of the second data item by the user in response to determining that an entry of the second data item does not comprise an exception to the captured event pattern.

6. The method of claim 2, further comprising:
determining whether an entry of response data that is received in response to prompting the user to enter the second data input satisfies a satisfaction threshold specified by the automated process for the response data;
in response to determining that the response data satisfies the satisfaction threshold, closing the linked second event; and
in response to determining that the response data does not satisfy the satisfaction threshold, iteratively repeating the steps of predicting as a function of the identification data, the role and the effective date, that the second event requires an additional, second data input, triggering the automated process in response to the predicting that the second event requires the additional second data input and prompting the user to enter the second data input, until a response data input is received that satisfies the satisfaction threshold.

7. The method of claim 2, wherein the steps of mapping the first data input to the first event, and predicting that the second event requires the additional, second data input, are further a function of geographic indicia of at least one of the individual and the role of the individual within the organization.

8. The method of claim 2, further comprising:
integrating computer-readable program code into a computer system comprising a processor, a computer readable memory in circuit communication with the processor, and a computer readable storage medium in circuit communication with the processor; and
wherein the processor executes program code instructions stored on the computer-readable storage medium via the computer readable memory and thereby performs the steps of mapping the first data input to the first event, predicting that the second event requires the additional second data input, triggering the automated process and prompting the user via the automated process to enter the second data input.

9. The method of claim 2, wherein the first data input further comprises temporal data that includes a date of another data input of another, different second data item that is linked to the effective date as a function of the mapping of the first event to the data input.

10. The method of claim 9, further comprising:
closing the second event in response to determining that the temporal data exceeds an expiration threshold of the second event.

11. A system, comprising:
a processor;
a computer readable memory in circuit communication with the processor; and
a computer readable storage medium in circuit communication with the processor;
wherein the processor executes program instructions stored on the computer-readable storage medium via the computer readable memory and thereby:
in response a first data input that comprises an effective date of the input and identification data that is unique to an individual and a role within an organization, maps the first data input to a first event of a plurality of pre-defined events as a function of the identification data, the role and the effective date;
in response to the mapping to the first event, predicts, as a function of the identification data, the role and the effective date, that a second event of the pre-defined events that is linked to the first event requires an additional, second data input for the individual that is different from the first data input,
triggers an automated process in response to the predicting that the second event requires the additional, second data input; and
prompts a user via the automated process to enter the second data input.

12. The system of claim 11, wherein the second event of the pre-defined events is linked to the first event as a function of aggregated anonymized organizational data of a plurality of other individuals that are employed within other organizations that are analogous to the organization, wherein confidential data and identification data that identify the other individuals are removed from the aggregated anonymized data.

13. The system of claim 12, wherein the processor executes the program instructions stored on the computer-readable storage medium via the computer readable memory and thereby further:
maps the first data input to the first event as a function of a relation of at least one of a salary level of the individual, a job title of the individual within the organization, and a length of time of the individual within the job title at the salary level, to corresponding data within the aggregated anonymized organizational data.

14. The system of claim 12, wherein the processor executes the program instructions stored on the computer-readable storage medium via the computer readable memory and thereby further:
automatically revises a security setting of an application programming interface of the organization to enable a spouse of the individual to enter the second data input, as a function of recognizing that the aggregated anonymized organizational data indicates that it is likely that the spouse is able to provide a data input response that satisfies a satisfaction threshold of the automated process.

15. The system of claim 12, wherein the processor executes the program instructions stored on the computer-readable storage medium via the computer readable memory and thereby further:
captures an event pattern as a function of the identification data, the role and the effective date of the first data input, in view of the aggregated anonymized organizational data; and
approves via the automated process entry of the second data item by the user in response to determining that an entry of the second data item does not comprise an exception to the captured event pattern.

16. A computer program product for event-driven behavior prediction, the computer program product comprising:
a computer readable hardware storage device having computer readable program code embodied therewith, wherein the computer readable hardware storage device is not a transitory signal per se, the computer readable program code comprising instructions for execution by a processor that cause the processor to:
in response a first data input that comprises an effective date of the input and identification data that is unique to an individual and a role within an organization, map the first data input to a first event of a plurality of pre-defined events as a function of the identification data, the role and the effective date;
in response to the mapping to the first event, predict, as a function of the identification data, the role and the effective date, that a second event of the pre-defined events that is linked to the first event requires an additional, second data input for the individual that is different from the first data input,
trigger an automated process in response to the predicting that the second event requires the additional, second data input; and
prompt a user via the automated process to enter the second data input.

17. The computer program product of claim 16, wherein the second event of the pre-defined events is linked to the first event as a function of aggregated anonymized organizational data of a plurality of other individuals that are employed within other organizations that are analogous to the organization, wherein confidential data and identification data that identify the other individuals are removed from the aggregated anonymized data.

18. The computer program product of claim 17, wherein the computer readable program code instructions for execution by the processor further cause the processor to:
determine whether an entry of response data that is received in response to prompting the user to enter the second data input satisfies a satisfaction threshold specified by the automated process for the response data;
in response to determining that the response data satisfies the satisfaction threshold, close the linked second event; and
in response to determining that the response data does not satisfy the satisfaction threshold, iteratively repeating steps of predicting as the function of the identification data, the role and the effective date, that the second event requires an additional, second data input, triggering the automated process, in response to predicting that the second event requires the additional second data input and prompting the user via the automated process to enter the second data input, until a response data input is received that satisfies the satisfaction threshold.

19. The computer program product of claim 17, wherein the computer readable program code instructions for execution by the processor further cause the processor to map the first data input to the first event and predict that the second event requires the additional, second data input as a function of geographic indicia of at least one of the individual and the role of the individual within the organization.

20. The computer program product of claim 17, wherein the first data input further comprises temporal data that includes a date of another data input of another, different second data item that is linked to the effective date as a function of the mapping of the first event to the data input; and
wherein the computer readable program code instructions for execution by the processor further cause the processor to close the second event in response to determining that the temporal data exceeds an expiration threshold of the second event.
